(19) United States
(12) Patent Application Publication
(10) Pub. No.: US 2005/0096949 A1
(43) Pub. Date: May 5, 2005

(54) Method and system for automatic continuous monitoring and on-demand optimization of business IT infrastructure according to business objectives

(75) Inventors: Sarel Aiber, Haifa (IL); David Botzer, Haifa (IL); Opher Etzion, Haifa (IL); Dagan Gilat, Haifa (IL); Natalia Razinkov, Or Akiva (IL); Aviad Sela, Yokneam Ilit (IL); Segev Wasserkrug, Haifa (IL)

Correspondence Address: Stephen C. Kaufman;Intellectual Property Law Dept., IBM Corporation, P.O. Box 218, Yorktown Heights, NY, 10598, US

(73) Assignee: International Business Machines Corporation, Armonk, NY (US)

(21) Appl. No.: 10/696,512

(22) Filed: Oct. 29, 2003

(51) Int. Cl. G06F 17/60

(52) U.S. Cl. 705/7

(57) ABSTRACT

A computer implemented method and system for optimizing performance of a business IT infrastructure, wherein business objectives are obtained as input and the IT business infrastructure and/or business level components associated therewith are optimized according to the business objectives. In one embodiment, an objectives definition is created that defines business objectives and business rules determining how IT level metrics affect the business objectives and, optionally, service level agreements or other contract definitions based on the objectives definition. A runtime performance of the business objectives is determined during runtime of the business IT infrastructure by monitoring the business IT infrastructure, its compliance with the contract definitions, and the business objectives achieved by the business IT infrastructure. If a statistically significant change is detected between the runtime performance and a reference optimization of the business objectives, the business model is updated and the reference optimization of the business objectives is re-determined.

### FIELD OF THE INVENTION

This invention relates to event-driven systems and, in particular, to a method and system for modeling and managing business and IT components and their inter-relationships.

### BACKGROUND OF THE INVENTION

All major enterprises today require their Information technology (IT) infrastructure to conduct business. This business IT infrastructure is composed both of the IT itself (hardware and software), and of the business processes which this IT supports. The purpose of this IT infrastructure is to support the enterprise's business objectives. Despite this fact, current goals for optimizing a business IT infrastructure typically focus on IT measures (e.g., increase the site availability by 1%), when what the enterprise really cares about are the business objectives, such as total income generated by the infrastructure.

Optimizing the IT infrastructure according to business objectives is not a trivial task, as it is unclear how settings of parameters at the IT level will affect the business objectives. Moreover, optimizing the IT infrastructure is not a one time effort, as there may be changes that occur in the environment in which the infrastructure operates, that may render any pre-defined setting suboptimal. Two examples of such changes are failures of hardware and software components, and significant changes in the usage characteristics of this infrastructure.

Therefore, what is required is both the recognition that a business must automatically and continuously optimize its IT infrastructure according to business metrics, and an automatic mechanism for carrying out this optimization, taking into account significant changes in the environment of the IT infrastructure.

U.S. 20030187709A1 (Brodsky et al.) published Oct. 2, 2003 and entitled “Adaptive enterprise optimization (AEO) framework and methods” discloses an Adaptive Enterprise Optimization (AEO) server that allows users to model their individual business entities or parts of the value chain through and to model their decision/optimization problems based on these business entities. This is done using a high level modeling language. Based on the models and user input data, the AEO server is able to automatically generate appropriate global optimization problems, and solve them using advanced mathematical programming and constraint database programming technologies.

This reference is fairly typical of adaptive models that optimize business decisions, but it does not discuss optimization of the business infrastructure itself in order to achieve specified business objectives.

U.S. Pat. No. 6,557,035 (McKnight) issued Apr. 29, 2003 and entitled “Rules-based method of and system for optimizing server hardware capacity and performance” discloses a method of optimizing server hardware performance and predicting server hardware bottlenecks monitors server hardware utilization parameters over a selected time period and computes the averages of the measurements. The method then compares the computed averages to thresholds. If some of the computed averages are equal to or greater than the threshold, the method reports a performance bottleneck and provides a recommended solution for the bottleneck. The method predicts a future server hardware performance bottleneck by computing running averages of the measured server utilization parameters. The method uses a linear regression analysis to determine a trend in the running averages and compares the trend to threshold values to predict the occurrence of a performance bottleneck.

While this patent relates to optimization of server hardware performance per se, it is not directed to the problem of optimization or fine-tuning of hardware performance in order to achieve optimal performance according to business objectives of business software run on the hardware.

There is therefore a need to provide an improved method and system for optimizing performance of a business IT infrastructure in order to achieve desired business objectives.

### SUMMARY OF THE INVENTION

It is therefore an object of the invention to provide an improved method and system for to provide an improved method and system for optimizing performance of a business IT infrastructure in order to achieve desired business objectives.

This object is realized in accordance with a broad aspect of the invention by a computer implemented method for optimizing an IT business infrastructure and business process parameters according to predetermined business objectives, the method comprising:
(a) obtaining as input business objectives; and
(b) optimizing the IT business infrastructure and/or business level components associated with the IT business infrastructure according to said business objectives.

In such a method the optimizing is performed by a suitably programmed computer, which is preferably further adapted to:
(c) continuously monitor the IT business infrastructure during run-time;
(d) determine whether a reference optimization of the IT business infra-structure and business level components needs updating; and
(e) if so, update the reference optimization of the IT business infrastructure and business level components according to the business objectives.

In accordance with one preferred embodiment of the invention, there is provided a computer implemented method of optimizing performance of a business IT infrastructure according to pre-defined business objectives, the method comprising:
(f) comparing runtime performance of the business objectives achieved by the IT infrastructure with a reference optimization of the business objectives based on a business model incorporating pre-defined business rules determining how IT level metrics affect said business objectives; and
(g) if a significant change is detected, updating the business model and re-determining the reference optimization of the business objectives.

### BRIEF DESCRIPTION OF THE DRAWINGS

In order to understand the invention and to see how it may be carried out in practice, a preferred embodiment will now be described, by way of non-limiting example only, with reference to the accompanying drawings, wherein identical reference numerals are used to refer to similar components and in which:

FIG. 1 is a block diagram showing functionally a computer system according to the invention for optimizing a business IT infrastructure;

FIG. 2 is a block diagram showing functionally a detail of the system depicted in FIG. 1 relating to optimization architecture;

FIG. 3 is a block diagram showing functionally a detail of the system depicted in FIG. 1 relating to architecture runtime implementation;

FIG. 4 is a block diagram showing the functional interrelationship between the optimizer and the business IT infrastructure that permits continuous optimization architecture; and

FIG. 5 is a flow diagram showing the principal operations carried out by the system according to the invention.

### DETAILED DESCRIPTION OF SPECIFIC EMBODIMENTS

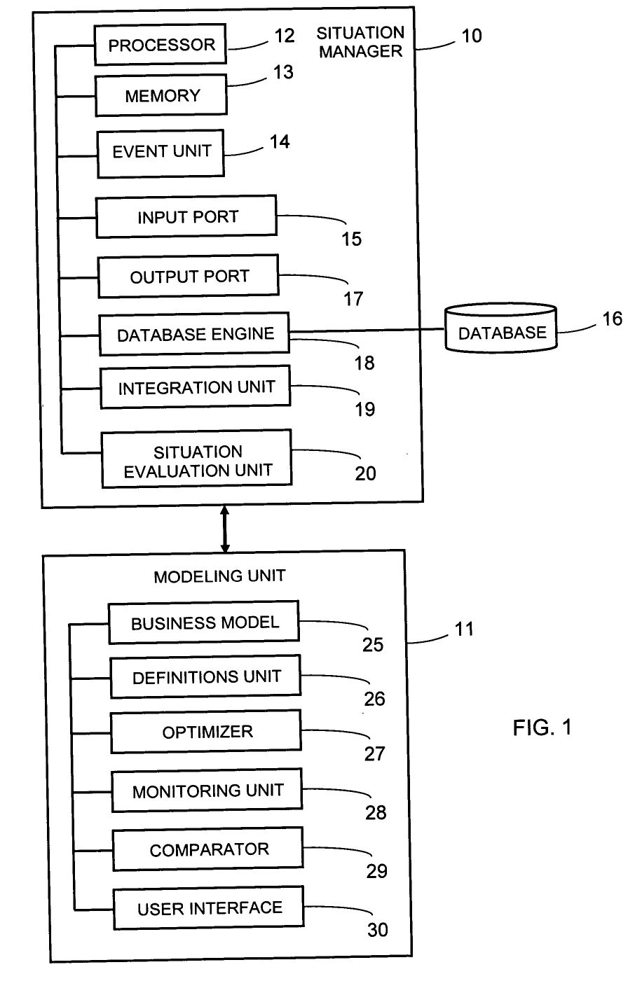

FIG. 1 is a block diagram showing functionally a situation manager depicted generally as 10 coupled to a modeling unit 11 according to the invention for modeling a business application. The situation manager 10 includes a processor 12 coupled to a memory 13 storing computer program code in accordance with which the situation manager 10 establishes a situation. The situation is established upon occurrence of one or more events, which are “pushed” to the situation manager 10 in known manner possibly in combination with auxiliary data defining relevant external knowledge for detection of the situation. The situation manager includes an event unit 14 for receiving one or more input events via an input port 15 to which events may be fed and to which an external database 16 may be coupled. An output port 17 allows the situation manager 10 to be coupled to an external device, such as a computer that is responsive to a desired situation being detected by the situation manager 10. A database engine 18 is coupled to the event unit 14 for querying the external database 16 for obtaining auxiliary data, and an integration unit 19 coupled to the event unit 14 and to the database engine 18 integrates the input event or events with the auxiliary data for establishing occurrence of a composite event, defining the situation. A situation evaluation unit 20 evaluates whether the composite event corresponds to the predetermined situation, and as noted above may be fed to an external device via the output port 17.

In a preferred embodiment of the invention, the situation manager 10 is an off-the-shelf situation awareness unit, such as that known by AMIT by International Business Machines Inc. of Armonk, N.Y., USA. AMIT is an acronym for “Active Middleware Technology” and is described in U.S. Pat. No. 6,604,093 (Etzion et al.) published Aug. 5, 2003, entitled “Situation awareness system” and commonly assigned to the present assignee. AMIT is a situation management system that provides tools for defining intervals during which a given situation is meaningful and for detecting and reacting to the occurrence of the situation during such intervals. Such an interval is referred to as a “lifespan” and begins with an initiating event, or initiator, and ends with a terminating event, or terminator. AMIT enables manipulation of the initiator and terminator, such as by attachment of conditions to the initiating and terminating events. It also allows multiple, interrelated lifespans to run concurrently, with predefined relations between the lifespans.

Thus, AMIT enables temporal relations among events to be defined and detected simply and flexibly and serves as a general purpose vehicle for implementing a vast range of different applications. The events that are processed by such a system and the manner in which they are derived depends on the application that is implemented using the system, it being understood that AMIT operates independently of the application even though it serves as a kernel to the application.

The modeling unit 11 comprises a memory (not shown) that stores a business model 25 and a definitions unit 26 that creates an objectives definition that defines business objectives. The business rules are input manually based on the business objectives and an Overall Business Metric as part of the input provided to ARAD. The internal AMIT engine is part of the simulation environment. The business rules determine how IT level metrics affect the business objectives as well service level agreements or other contract definitions based on the objectives definition, although service level agreements or other contract definitions are not mandatory A service level agreement is a contractual agreement between two parties—a service provider—that provides a service, and a service consumer, regarding some service level, such as “ensuring that 95% of all transactions have a response time less then 3 seconds”. A service level agreement usually has two numerical quantities associated with it: a price paid by service consumer to ensure the service level agreement, and a penalty paid by the service consumer whenever the agreement is violated. There are several formalisms for specifying service level agreements. One such approach is described by Ludwig et al. in “A Service Level Agreement Language for Dynamic Electronic Services” published in Fourth IEEE International Workshop on Advanced Issues of E-Commerce and Web-Based Information Systems (WECWIS'02), Jun. 26-28, 2002, p.25. However, these can also be specified using the situation manager rule language, such as AMIT in the preferred embodiment. An optimizer 27 is coupled to the definitions unit 26 and determines a reference optimization of the business objectives based on the business model 25 incorporating the business rules and service level agreements or contract definitions as fed thereto by the definitions unit 26. A monitoring unit 28 monitors the performance of the IT infrastructure in respect of business objectives during runtime, and a comparator 29 coupled to the monitoring unit 28 compares the runtime performance of the business infrastructure in achieving the desired business objectives with the reference optimization achieved by the business model. If the difference between the runtime performance of the business infrastructure in achieving the desired business objectives and the reference optimization is significant, the business model 25 is automatically updated and optimizer 27 re-determines the reference optimization of the business objectives.

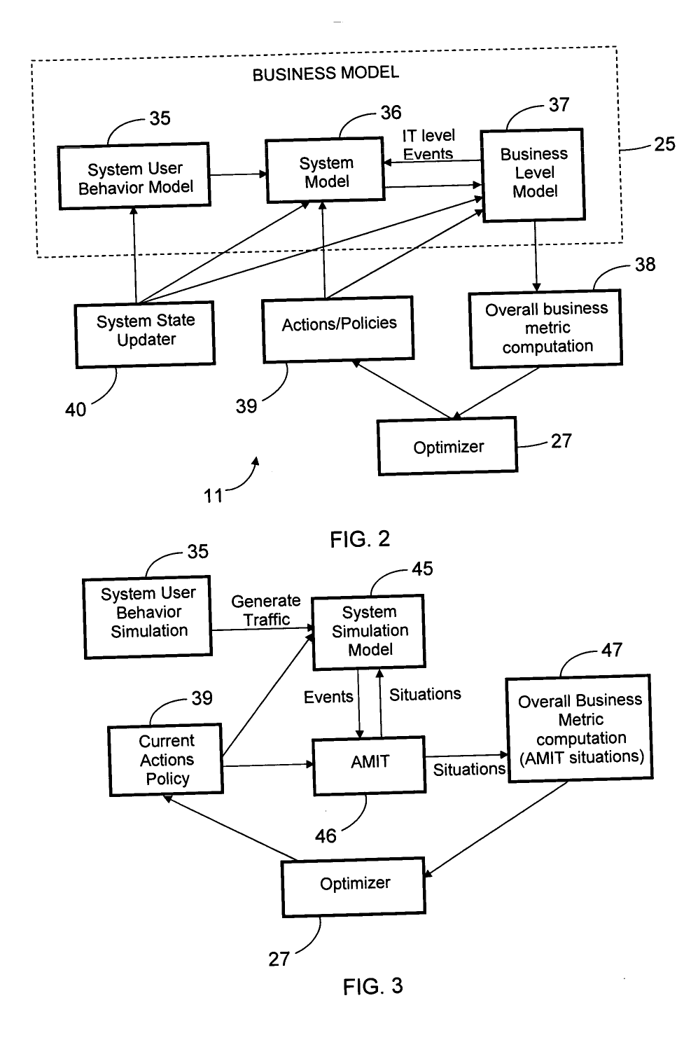

FIG. 2 is a block diagram showing functionally a detail of that part of the system depicted in FIG. 1 relating to the optimization architecture. A System User Behavior Model 35 models the behavior of the users of the business application. This model takes into account parameters such as the number of users, the types of users, and the manner in which each user uses the system. The System Model 36 models the IT itself—this includes the hardware and software components of the IT business infrastructure. The System Model 36 should take into account the following:
i. The hardware configuration of the IT—e.g., number of servers, number of CPUs on each servers, network configuration, etc.
ii. The software—the applications supported, the behavior of these applications and the resources required by each application.
iii. The manner in which the users of the IT infrastructure use the systems supported by this infrastructure.

A Business Level Model 37 allows the calculation of the business metrics and is used to calculate the impacts of events at the IT level on the business objectives, as well as serving as inputs to an overall business metric computation 38, which is the quantity that measures the overall alignment of the IT infrastructure with the business objectives. The Business Level Model 37 may include things such as gains from commissions, explicit penalties paid to customers whenever service level guarantees are violated, customers deserting due to poor service, gaining new customers due to a good reputation, and losing customers due to poor reputation. In order to enable optimization, this economic model should also enable the calculation of an “end result”—a single quantity that can be used to quantify the alignment of the IT with the business objectives. An example of such a quantity is the total income generated by the IT infrastructure. This quantity may be referred to as the overall business metric.

The System User Behavior Model 35, the System Model 36 and the Business Level Model 37 together constitute the business model 25 shown in FIG. 1, which models all IT aspects of the business IT infrastructure. This unified IT level model can be used to generate the IT level events, on top of which the business level models are defined.

Another aspect that is modeled in the architecture is a set of Actions/Policies 39 that can be changed by the optimizer 27. For a given set of actions or policies, the set of components described above can be used to calculate the value of the overall business metric. There are many possible examples of actions or policies—both at the IT and business level. One example of an IT level policy is a queuing policy, that determines the priority of incoming customers requests according to fields accompanying the request such as customer ID, customer type, amount in request, etc., so that higher priority requests are served before others. Setting such parameters has a potentially high impact on business objectives, as for example, requests from customers that increase the income more should be assigned a higher priority. An example of a business level policy or action is the penalty amount paid when violating service level agreements, based on rules such as how low penalties affect market share. It should be noted that just by using the above-described models, “what-if” analysis can be carried out, and can be used to make managerial decisions based on business objectives and return on investment (ROI).

All of the above models are coupled to the optimizer 27 that carries out a search on the set of allowable actions or policies, and attempts to find the set of actions/policies that optimizes the overall business metric. A System State Updater 40 is used to update all of the above models, whenever a significant difference is detected between the optimized models as determined by the optimizer 27 (and constituting the reference optimization), and the actual performance of the business IT infrastructure.

The above is a general architecture. For each type of model described above (System User Behavior model, System Model, etc.), several methods may be used to implement it. Examples are:

2. For the System User behavior model and the System models:
i. Simulation methods—e.g. discrete event simulations.
ii. Analytical models—e.g. queuing network models iii. Functional models—e.g. neural network models.
iv. Some combination of the above.

3. For the business level models, general methods which can be used are:
i. Rule based models.
ii. Specific economic models.
iii. Some combination of the above.

4. Many algorithms and paradigms can also be used for optimization. Examples are:
i. Tabu search based methods.
ii. Simulated annealing.
iii. Genetic algorithms.

### A Specific Implementation of the Architecture

FIG. 3 is a block diagram showing functionally a detail of the system depicted in FIG. 1 relating to architecture implementation when AMIT is incorporated within the models, and is used to model the business objectives and contracts. In the context of the invention and appended claims, the term “contract” relates to an obligation by or to an owner or user of the IT business infrastructure. In such case, AMIT serves as a situation awareness unit for analyzing events created by the business model and creating situations that are then used by the business model. It should, however, be noted that other situation awareness units can be used in conjunction with the models appearing in the above general architecture. The model depicted in FIG. 3 is based on the following:

1. Both the System User Behavior Model 35 and the System Model 36 are modeled using discrete event simulation techniques. This creates a unified simulation model 45 at the IT level.

2. The mechanism for expressing both the impact of the IT level rules on the business objectives and the calculation of the overall business objectives is the AMIT technology. As noted above, AMIT is a rule based technology that allows the calculation of such business objectives based on events.

The unified IT simulation model 45 creates events, which are fed into the AMIT engine 46, allowing the calculation by the AMIT engine of the impact of the IT level events on the business metrics, and the calculation of the overall Business Level Objective. Situations determined by the AMIT engine 46 are fed both to the System Simulation Model 45 and to the Overall Business Metric computation. Both the impact of the IT level events on the business metrics, and the calculation of the overall Business Level Objective are calculated by one AMIT engine, using a set of rules. The division here is more a logical division—between a first set rules that specify how IT level events affect the business objectives, and a second set of rules from which the Overall Business Metric is calculated.

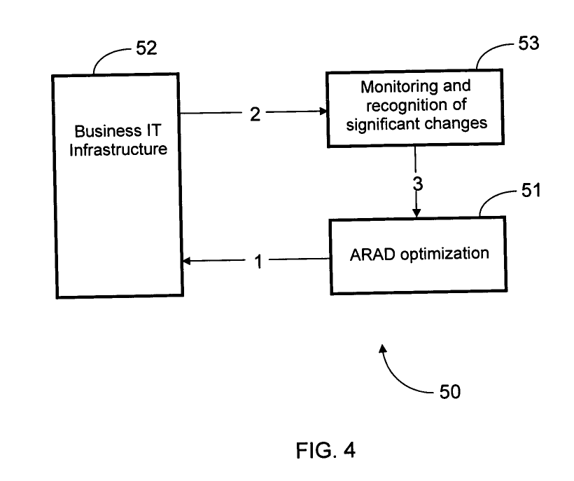

FIG. 4 is a block diagram showing a continuous optimization architecture 50 that is facilitated by the functional interrelationship between an ARAD optimization 51 and the business IT infrastructure depicted as 52. The following process is shown in FIG. 4.

1. Using the ARAD optimization 51, an initial configuration of the business IT infrastructure 52 is found.

2. As long as no significant changes are detected between the business IT infrastructure 52 and the ARAD model—the ARAD optimization process continues to look for better solutions. Whenever a better configuration for the IT infrastructure 52 is found using the current ARAD optimization model 51—the configuration of the IT infrastructure 52 is changed via the interface denoted by arrow 1.

3. The IT infrastructure 52 is continuously monitored using the interface denoted by arrow 2, using the monitoring unit 28 (shown in FIG. 1).

4. Whenever the monitoring unit 28 recognizes a significant discrepancy between the IT infrastructure 52 and the ARAD model, the ARAD model is updated through the interface denoted by 3, and the ARAD optimization process is restarted.

### Recognition of Significant Differences and Model Updates

As noted above, the comparator 29 compares the actual business IT infrastructure and the ARAD optimization model and determines whether the difference is significant. Therefore, it is necessary to define both what constitutes such a difference, and an algorithm for recognizing such differences and updating the optimization model accordingly.

A significant difference may be defined as a difference between the business objectives and metrics measured on the actual IT infrastructure, and the same metrics as predicted by the ARAD models that is defined as “significant” according to predetermined criteria. It is thus necessary to pre-define what constitutes a significant difference between the model and the actual infrastructure. In one embodiment of the invention, only differences between business objectives as calculated by the models and the actual business objectives as measured by the IT infrastructure are taken into account. In such an embodiment, it is not necessary to look at differences of other parts of the model, for example the incoming traffic, as the assumption is that if it does not impact the business objectives, it does not matter. Then, as noted above, it is necessary to define what constitutes a significant difference between the modeled business objectives and measured business objectives, and this is defined by statistical tests such as Chi-squared, when the measured business objectives are treated as the actual distribution, and the modeled business objectives are treated as the empirical distribution.

An algorithm for recognizing this difference and updating the models may be defined as follows:

1. The same business objectives that are optimized against in the optimization process are continuously measured on the actual IT infrastructure, and compared against the business level objectives predicted by the optimization model during corresponding time windows, using statistical tests.

2. Another copy of the models is continuously updated using monitoring information from the actual system, but is not incorporated into the optimization model.

3. Only when a significant difference as defined above is detected in step 1, are the new models incorporated into the optimization model, and the optimization process is restarted.

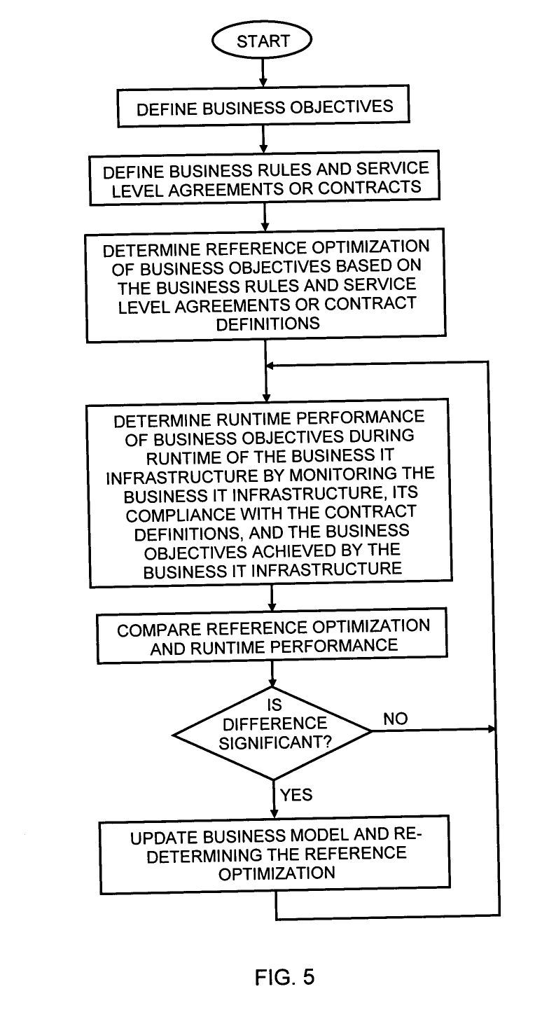

FIG. 5 is a flow diagram showing the principal operations carried out by the system according to the invention. An objectives definition is created that defines business objectives and business rules determining how IT level metrics affect the business objectives and service level agreements or other contract definitions based on the objectives definition. A reference optimization of the business objectives is likewise determined based on a business model incorporating the business rules and service level agreements or contract definitions and the IT model. A runtime performance of the business objectives is determined during runtime of the business IT infrastructure by monitoring the business IT infrastructure, its compliance with the contract definitions, and the business objectives achieved by the business IT infrastructure. The reference optimization is compared with the runtime performance and if a statistically significant change is detected, the business model is updated and the reference optimization of the business objectives is re-determined.

It will be understood that FIG. 5 represents only one approach to optimizing the IT business infrastructure and/or business level components associated therewith according to the predetermined business objectives. The invention contemplates any computer-implemented method for doing this regardless of how the business model is defined, how its performance is monitored or how it is determined whether the reference optimization of the IT business infrastructure and business level components needs updating.

It will also be understood that the situation manager according to the invention may be a suitably programmed computer. Likewise, the invention contemplates a computer program being readable by a computer for executing the method of the invention. The invention further contemplates a machine-readable memory tangibly embodying a program of instructions executable by the machine for executing the method of the invention.

In the method claims that follow, alphabetic characters and roman numerals used to designate claim steps are provided for convenience only and do not imply any particular order of performing the steps.

1. A computer implemented method for optimizing an IT business infra-structure and business process parameters according to predetermined business objectives, the method comprising:
(a) obtaining as input business objectives; and
(b) optimizing the IT business infrastructure and/or business level components associated with the IT business infrastructure according to said business objectives.

2. The method according to claim 1, further including:
(a) continuously monitoring the IT business infrastructure during run-time;
(b) determining whether a reference optimization of the IT business infrastructure and business level components needs updating; and
(c) if so, updating the reference optimization of the IT business infra-structure and business level components according to the business objectives.

3. The method according to claim 1, wherein the business objectives include a service level agreement between a service provider that provides a service and a service consumer, regarding some service level.

4. The method according to claim 3, wherein the service level agreement has two numerical quantities associated therewith: a price paid by the service consumer to ensure the service level agreement, and a penalty paid by the service consumer whenever the agreement is violated.

5. The method according to claim 3, wherein the business objectives include a contract relating to an obligation by or to an owner or user of the IT business infrastructure.

6. The method according to claim 1, wherein the business model includes a system user behavior model that models behavior of users of a business application running on the IT infrastructure.

7. The method according to claim 1, wherein the system user behavior model takes into account parameters such as the number of users, the types of users, and the manner in which each user uses the system.

8. The method according to claim 1, wherein the business model includes a system model that models hardware and software components of the IT infra-structure.

9. The method according to claim 8, wherein the system model takes into account:
hardware configuration of the IT infrastructure;
software applications supported on the IT infrastructure, their behavior and resources required by each application; and
manner in which the users of the IT infrastructure use the systems supported thereby.

10. The method according to claim 1, wherein the business model includes a business level model that allows the calculation of said IT metrics and is used to calculate the impacts of events at the IT level on the business objectives, as well as serving as inputs for computing an overall business metric, being a quantity that measures an overall alignment of the IT infrastructure with the business objectives.

11. The method according to claim 1, wherein the business level model includes at least one from the group including: gains from commissions, explicit penalties paid to customers whenever service level guarantees are violated, customers deserting due to poor service, gaining new customers due to a good reputation, and losing customers due to poor reputation.

12. The method according to claim 1, wherein the business model allows calculation of an overall business metric that can be used to quantify the alignment of the IT with the business objectives.

13. The method according to claim 12, wherein the overall business metric is a total income generated by the IT infrastructure.

14. The method according to claim 2, wherein a need to update the reference optimization of the IT business infrastructure and business level components is determined by statistical tests such as Chi-squared, when the measured business objectives are treated as an actual distribution, and the modeled business objectives are treated as an empirical distribution.

15. A computer implemented program storage device readable by machine, tangibly embodying a program of instructions executable by the machine to perform method steps for optimizing an IT business infrastructure and business process parameters according to predetermined business objectives, the method comprising:
(a) obtaining as input business objectives; and
(b) optimizing the IT business infrastructure and/or business level components associated with the IT business infrastructure according to said business objectives.

16. A computer implemented computer program product comprising a computer useable medium having computer readable program code embodied therein for optimizing an IT business infrastructure and business process parameters according to predetermined business objectives, the computer program product comprising:
computer readable program code for causing the computer to obtain as input business objectives; and
computer readable program code for causing the computer to optimize the IT business infrastructure and/or business level components associated with the IT business infrastructure according to said business objectives.

17. A computer implemented method for optimizing performance of a business IT infrastructure according to pre-defined business objectives, the method comprising:
(a) comparing runtime performance of the business objectives achieved by the IT infrastructure with a reference optimization of the business objectives based on a business model incorporating pre-defined business rules determining how IT level metrics affect said business objectives; and
(b) if a significant change is detected, updating the business model and re-determining the reference optimization of the business objectives.

18. The method according to claim 17, including:
(c) determining the runtime performance of said business objectives during runtime of the business IT infrastructure by monitoring the business IT infrastructure and the business objectives achieved by the business IT infrastructure.

19. The method according to claim 17, wherein the business objectives include a service level agreement between a service provider that provides a service and a service consumer, regarding some service level.

20. The method according to claim 19, wherein the service level agreement has two numerical quantities associated therewith: a price paid by the service consumer to ensure the service level agreement, and a penalty paid by the service consumer whenever the agreement is violated.

21. The method according to claim 19, wherein the business objectives include a contract relating to an obligation by or to an owner or user of the IT business infrastructure.

22. The method according to claim 17, wherein the business model includes a system user behavior model that models behavior of users of a business application running on the IT infrastructure.

23. The method according to claim 17, wherein the system user behavior model takes into account parameters such as the number of users, the types of users, and the manner in which each user uses the system.

24. The method according to claim 17, wherein the business model includes a system model that models hardware and software components of the IT infra-structure.

25. The method according to claim 24, wherein the system model takes into account:
hardware configuration of the IT infrastructure;
software applications supported on the IT infrastructure, their behavior and resources required by each application; and
manner in which the users of the IT infrastructure use the systems supported thereby.

26. The method according to claim 17, wherein the business model includes a business level model that allows the calculation of said IT metrics and is used to calculate the impacts of events at the IT level on the business objectives, as well as serving as inputs for computing an overall business metric, being a quantity that measures an overall alignment of the IT infrastructure with the business objectives.

27. The method according to claim 17, wherein the business level model includes at least one from the group including: gains from commissions, explicit penalties paid to customers whenever service level guarantees are violated, customers deserting due to poor service, gaining new customers due to a good reputation, and losing customers due to poor reputation.

28. The method according to claim 17, wherein the business model allows calculation of an overall business metric that can be used to quantify the alignment of the IT with the business objectives.

29. The method according to claim 28, wherein the overall business metric is a total income generated by the IT infrastructure.

30. The method according to claim 17, wherein significance of a change is defined by statistical tests such as Chi-squared, when the measured business objectives are treated as an actual distribution, and the modeled business objectives are treated as an empirical distribution.

31. A system for optimizing performance of a business IT infrastructure according to pre-defined business objectives, the system comprising:
a comparator for comparing runtime performance of the business objectives achieved by the IT infrastructure with a reference optimization of the business objectives based on a business model incorporating pre-defined business rules determining how IT level metrics affect said business objectives; and
an optimizer for updating the business model and re-determining the reference optimization of the business objectives if a significant change is detected.

32. The system according to claim 31, comprising a modeling unit for defining the business model.

33. The system according to claim 32, wherein the modeling unit includes a definitions unit that is coupled to the optimizer and creates an objectives definition that defines business objectives.

34. The system according to claim 32, wherein the modeling unit includes a monitoring unit that monitors the performance of the IT infrastructure in respect of business objectives during runtime.

35. The system according to claim 31, wherein the business model includes a set of actions/policies that can be changed by the optimizer.

36. The system according to claim 32, wherein the modeling unit is coupled to an independent situation manager that establishes a situation upon occurrence of one or more events occurring during runtime of the business model on the IT infrastructure.

37. A computer implemented program storage device readable by machine, tangibly embodying a program of instructions executable by the machine to perform method steps for optimizing performance of a business IT infrastructure according to pre-defined business objectives, the method comprising:
(a) comparing runtime performance of the business objectives achieved by the IT infrastructure with a reference optimization of the business objectives based on a business model incorporating pre-defined business rules determining how IT level metrics affect said business objectives; and
(b) if a significant change is detected, updating the business model and re-determining the reference optimization of the business objectives.

38. A computer implemented computer program product comprising a computer useable medium having computer readable program code embodied therein for optimizing performance of a business IT infrastructure according to pre-defined business objectives, the computer program product comprising:
computer readable program code for causing the computer to compare runtime performance of the business objectives achieved by the IT infrastructure with a reference optimization of the business objectives based on a business model incorporating pre-defined business rules determining how IT level metrics affect said business objectives; and
computer readable program code for causing the computer to update the business model and re-determine the reference optimization of the business objectives, if a significant change is detected.
